(19) United States
(12) Patent Application Publication
(10) Pub. No.: US 2024/0403258 A1
(43) Pub. Date: Dec. 5, 2024

(54) CHIPLET AWARE ADAPTABLE QUANTIZATION

(71) Applicant: Applied Materials, Inc., Santa Clara, CA (US)

(72) Inventors: Bilal Shafi Sheikh, Milpitas, CA (US); Tameesh Suri, San Jose, CA (US); Nathaniel See, Fremont, CA (US); Sutapa Dutta, Kolkata (IN); Yun-Ting Sun, Saratoga, CA (US); Udaykumar Diliprao Hanmante, Udgir (IN); Naveed Zaman, Saratoga, CA (US)

(73) Assignee: Applied Materials, Inc., Santa Clara, CA (US)

(21) Appl. No.: 18/328,852

(22) Filed: Jun. 5, 2023

(51) Int. Cl. G06F 15/78; G06N 5/04

(52) U.S. Cl. CPC G06F 15/7807; G06N 5/04

(57) ABSTRACT

A chiplet-based architecture may quantize, or reduce, the number of bits at various stages of the data path in an artificial-intelligence processor. This architecture may leverage the synergy between quantizing multiple dimensions together to greatly decrease the memory usage and data path bandwidth. Internal weights may be quantized statically after a training procedure. Accumulator bits and activation bits may be quantized dynamically during an inference operation. New hardware logic may be configured to quantize the outputs of each operation directly from the core or other processing node before the tensor is stored in memory. Quantization may use a statistic from a previous tensor for a current output tensor, while also calculating a statistic to be used on a subsequent output tensor. In addition to quantizing based on a statistic, bits can be further quantized using a Kth percentile clamping operation.

### TECHNICAL FIELD

This disclosure generally describes chiplet-based processing architectures. More specifically, this disclosure describes quantization techniques within an chiplet-based or tile-based artificial intelligence architecture.

### BACKGROUND

A chiplet is a modular integrated circuit that is specifically designed to work with other similar modular chiplets to form a larger, more complex processing system. This allows functional blocks to be divided up into different chiplets in a design to provide greater flexibility and modularity during the design process. In contrast to conventional monolithic integrated circuit (IC) designs, chiplet-based designs use smaller independent dyes that are connected together. Each chiplet may be specifically designed to perform individual functions, such as processing cores, graphic processing units, math coprocessors, hardware accelerators, and so forth. Chiplet-based designs also decrease the cost of manufacturing, as a larger die may be divided into smaller chiplets to improve yield and binning. With the increased cost and slowing of Moore's law, conventional monolithic chip development is also becoming less attractive, as chiplets are less expensive and exhibit faster time-to-market production. The emergence of a relatively new chiplet-based ecosystem is beginning to enable an alternative way to design complex systems by integrating pre-tested chiplet dies into a larger package.

In the modern artificial intelligence (AI) landscape, there is a greater need to optimize AI operations across hardware and software stacks. Specifically, the number of use cases continues to multiply across AI workloads, from image classification to heavier workloads such as natural language processing. This leads to more complex and larger AI workloads that require billions of operations and very large memory requirements to store the model activations and weights. For example, modern convolutional neural networks for image classification may require as much as 45 million parameters. More complex transformer-based models for natural language processing may use as many as 1.6 trillion parameters. These complex models further constrain existing computing resources during inference, which leads to more challenging performance scaling with present hardware. For chiplet-based designs, these larger parameter data sets and complex models may result in more data movement tasks. This increases the data flow interconnect bandwidth between multi-tile or chiplet-based heterogeneous scaling architectures used in AI data accelerators. Therefore, improvements in the art are needed.

### SUMMARY

In some embodiments, a multi-chiplet artificial intelligence processor may include a plurality of chiplets each configured to perform a portion of an inference operation by calculating partial sums that are combined to generate an activation output. The processor may also include a plurality of quantization blocks that are implemented on the plurality of chiplets and configured to individually quantize outputs of each of the plurality of chiplets. The plurality of chiplets may include a first chiplet and a second chiplet. An output of the first chiplet may be quantized to a different number of bits than an output of the second chiplet.

In some embodiments, an artificial intelligence (AI) accelerator pipeline may include a core configured to perform an activation operation on an input tensor and generate an output tensor, a memory that stores the input tensor and stores the output tensor after being generated by the core, and quantization logic configured to quantize the output tensor after being generated by the core and before being stored in the memory. The quantization logic may quantize the output using a first statistic from a previous input tensor. The pipeline may also include update logic configured to calculate a second statistic that is stored and used by the quantization logic to quantize and output from a subsequent input tensor.

In some embodiments, a method of performing an activation operation in an AI accelerator pipeline may include performing the activation operation on an input tensor to generate an output tensor, and quantizing the output tensor before the output tensor is stored in a memory. The output tensor may be quantized using a first statistic calculated from a previous input tensor. The method may also include calculating a second statistic that is stored and used to quantize an output from a subsequent input tensor. The second statistic may be calculated from the output tensor before the output tensor is stored in the memory, and storing the output tensor in the memory.

In any embodiments, any and all of the following features may be implemented in any combination and without limitation. The first chiplet may receive a partial sum output from the second chiplet, and the output of the first chiplet may be quantized to a fewer number of bits than the output of the second chiplet. The output of the first chiplet may be quantized to between 2 bits and 6 bits, and the output of the second chiplet may be quantized to between 4 bits and 8 bits. The plurality of chiplets may be arranged in a two-dimensional (2D) grid, each column in the 2D grid may process a subset of bits from an input tensor comprising at least 32 bits, and each row in the 2D grid may be quantized at greater than or equal to a number of bits in a previous row. The activation output may be further quantized to between 6 and 8 bits after combining the partial sums. The quantization blocks may be further configured to quantize the outputs of each of the plurality of chiplets using a K^{th} percentile after quantizing using a statistic from a previous input tensor. The quantization blocks may be further configured to quantize the outputs of each of the plurality of chiplets using a statistic from a previous input tensor. The quantization blocks may be further configured to calculate a statistic during the inference operation to be used on a subsequent inference operation with a subsequent input tensor. The quantization logic may include hardware that quantizes the output tensor directly from the core such that the output tensor is not stored in the memory after being generated by the core and before being quantized using the first statistic by the quantization logic. The update logic may include hardware that calculates the second statistic directly from the core such that the output tensor is not stored in the memory after being generated by the core and before being used by the update logic to calculate the second statistic. The quantization logic may dynamically quantize the output from the core during an inference operation. The core may include a plurality of internal weights that are statically quantized before performing an inference operation. An internal accumulator may also be quantized along with the plurality of internal weights and the output tensor, and the output tensor and the internal weights may be quantized to 8 or fewer bits.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a chiplet-based design, according to some embodiments.

FIGS. 2A-2C illustrate synergies when quantizing a plurality of different metrics in an AI architecture, according to some embodiments.

FIG. 3 illustrates an example of static quantization, according to some embodiments.

FIG. 4 illustrates an example of dynamic quantization, according to some embodiments.

FIG. 5 illustrates an AI architecture using a running statistical optimization for dynamic quantization, according to some embodiments.

FIG. 6 illustrates a distribution of a metric, such as a set of weights or activations, according to some embodiments.

FIG. 7 illustrates a pipeline that may be used in an AI accelerator architecture, according to some embodiments.

FIG. 8 illustrates a scalable chiplet architecture where partial sums are quantized, according to some embodiments.

FIG. 9 illustrates an exemplary computer system, in which various embodiments may be implemented.

### DETAILED DESCRIPTION

A chiplet-based architecture may quantize, or reduce, the number of bits at various stages of the data path in an artificial-intelligence (AI) processor. Instead of only quantizing a single dimension, this architecture may leverage the synergy between multiple dimensions to greatly decrease the memory usage and data path bandwidth. Internal weights may be quantized statically after a training procedure. Accumulator bits and activation bits may be quantized dynamically during an inference operation. By way of example, bit widths may be quantized to 8 or fewer bits without sacrificing much in the way of accuracy. To reduce the memory read/write overhead during an inference operation, new hardware logic may be configured to quantize the outputs of each operation directly from the core or other processing node before the tensor is stored in memory. Quantization may use a statistic from a previous tensor for a current output tensor, while also calculating a statistic to be used on a subsequent output tensor. In addition to quantizing based on a statistic (e.g., min/max values), bits can be further quantized using a Kth percentile clamping operation.

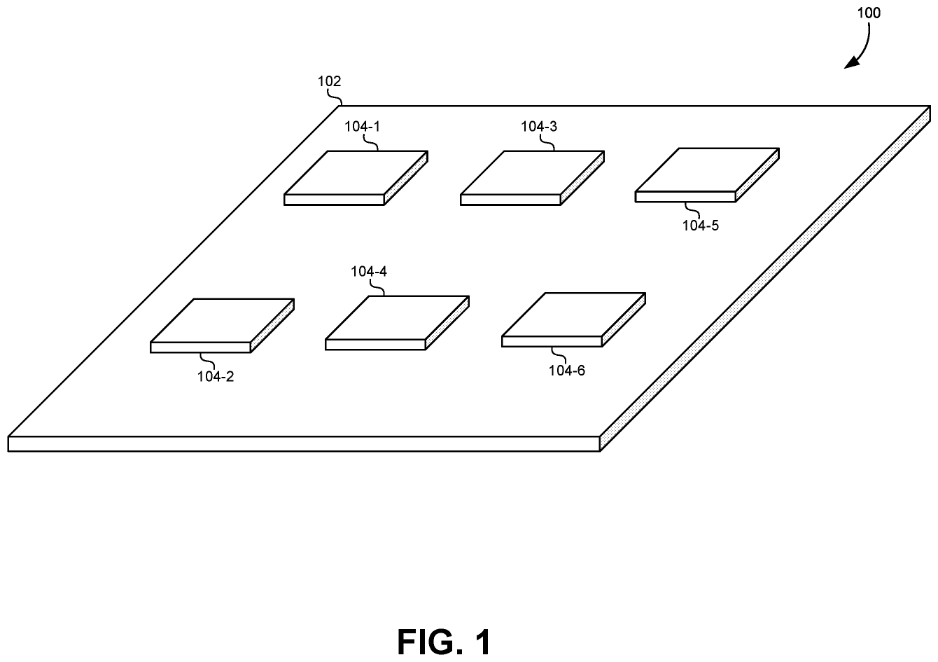

FIG. 1 illustrates a chiplet-based system 100, according to some embodiments. A plurality of chiplets 104 may be manufactured as separate dies from one or more silicon wafers. The chiplets 104 may include a plurality of different functions, such as application-specific systems-on-a-chip (SOCs), a GPU, a digital signal processor (DSP), an artificial intelligence (AI) accelerator, various codecs, Wi-Fi communication modules, memory controllers, caches, input/output (I/O) peripherals, and so forth. Although manufactured on separate dies, each of these chiplets 104 may be connected together using various options to perform substantially the same functions as would be performed by a similar monolithic design, but in a more distributed manner.

In some embodiments, the chiplet-based system 100 may include a plurality of individual tiles that implement a function or distributed processing system. For example, some embodiments described below may implement an AI accelerator using a plurality of chiplets in the chiplet-based system 100. Each chiplet or tile may be configured to handle a slice or portion of the AI architecture calculation or pipeline. Columns of chiplets may be used to calculate partial sums that may later be combined or concatenated to form a final layer output for a neural network model. This chiplet-based distributed system greatly simplifies the processing operations that take place on each chiplet. However, this simultaneously complicates the communication, data routing, and bandwidth demands between the chiplets. For example, a plurality of distributed chiplets in the chiplet-based system 100 may be used to implement a pipeline of multiply-accumulate (MAC) operations. An example of a chiplet-based distributed and scalable AI architecture is described in greater detail below.

The embodiments described herein may utilize quantization, which is a technique or algorithm which is used to reduce the representation size of data in AI workloads. Specifically some embodiments may utilize mixed-precision quantization, which uses scalable architectures and hardware to further reduce interconnect bandwidth by quantizing the output of individual chiplets in a distributed architecture. Prior to this disclosure, the industry standard for data representation was floating-point 32 (i.e., 32 bits to represent a floating-point number in a computer memory). Quantization can be used to reduce the representation size to a smaller range, such as 16-bit integers. By reducing the representation size of the data, this in turn reduces the memory requirements needed to store the data. For chiplet-based or multi-tile designs, this also reduces the interconnect bandwidth required to transfer data throughout the system, which reduces power consumption considerably.

Reduced-precision hardware may be used to support neural network scaling. The embodiments described herein may leverage synergies in the coordinated quantization of weights, activations, and internal accumulator representations that may be used to modify deep learning platforms and improve performance. Specifically, memory reduction is significantly reduced without significantly reducing the accuracy of the results during inference. Instead of simply focusing on quantizing the weights in a neural network, these embodiments may quantize the weights, activations, and/or internal accumulator representations together for greater effect. As opposed to traditional quantization, which was limited to quantizing model weights or another single parameter for lower precision for a reduced memory footprint, these embodiments may coordinate the quantization of weights with the quantization of activations and internal accumulators together in a coordinated manner.

The quantization principle may then be extended to a multi-chiplet platform with a scalable chiplet architecture that includes multiple chiplets. Each of the chiplets may be used to compute partial sums in the AI architecture, and the data from these partial sums may be combined to obtain the final layer output in the neural network. For example, each partial-sum output from the chiplets may be quantized to a different, individual bit width that allows for mixed-precision partial results within the architecture that can be dynamically updated during each iteration based on actual runtime data values during inference. Specifically, the outputs of each chiplet can be quantized to a different optimized value based on the contents of the data. This type of individual quantization allows the system to maintain the accuracy of the model while still reducing memory usage and interconnect bandwidth. While each accumulator may have lower precision for each chiplet, the partial sums may be combined to maintain the overall accuracy of the result.

This disclosure first describes an architectural framework that is adapted to leverage synergies in quantization between the weights, activations, and/or internal accumulator representations within a multi-tile or chiplet-based scaling platform. This type of quantization can then be extended to scalable multi-chiplet architectures where each chiplet computes an activation partial sum. This represents a mixed-precision architecture where AI workload activations may be quantized to different bit-widths for multiple layers in order to optimize overall performance. The accumulator may be distributed among a plurality of chiplets, with each quantizing the corresponding partial activation to a variable bit-width to further reduce the interconnect bandwidth. A final quantized layer output may be generated using an algorithm- and -hardware combined design approach.

Generally, quantizing weights and activations requires the accumulator to be set to a higher precision, which is dependent on the precision of the model parameters. For example, if the weights and the activations are quantized to 8 bits, the accumulator may be quantized to 32 bits. Distributing workloads among a multi-chip architecture may allow the architecture to compute partial sums for a single convolution operation that can be quantized to lower mixed-precision values. Distributing workloads among a multi-chiplet architecture allows the architecture to compute partial sums for a single convolution operation that can then be quantized to lower mixed-precision values and combined to produce the final output.

Some embodiments may determine (1) minimum and/or maximum values for each partial sum in order to clip and scale down a result to a smaller bandwidth, and (2) whether this quantization should be carried out statically or dynamically. In dynamic quantization, weights may be quantized ahead of time, whereas activations may be quantized at runtime during inference. During inference, quantized weights and activations may require an accumulator that is set to a higher precision as mentioned above.

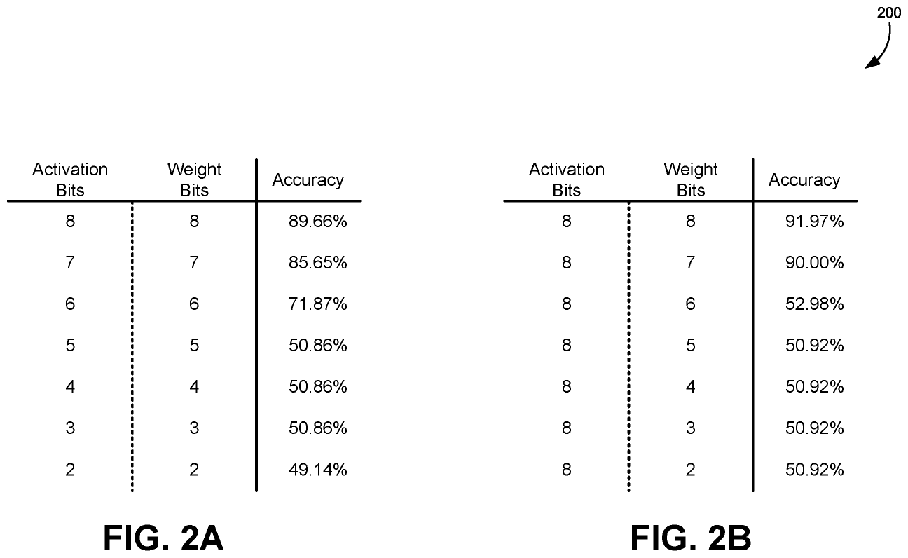

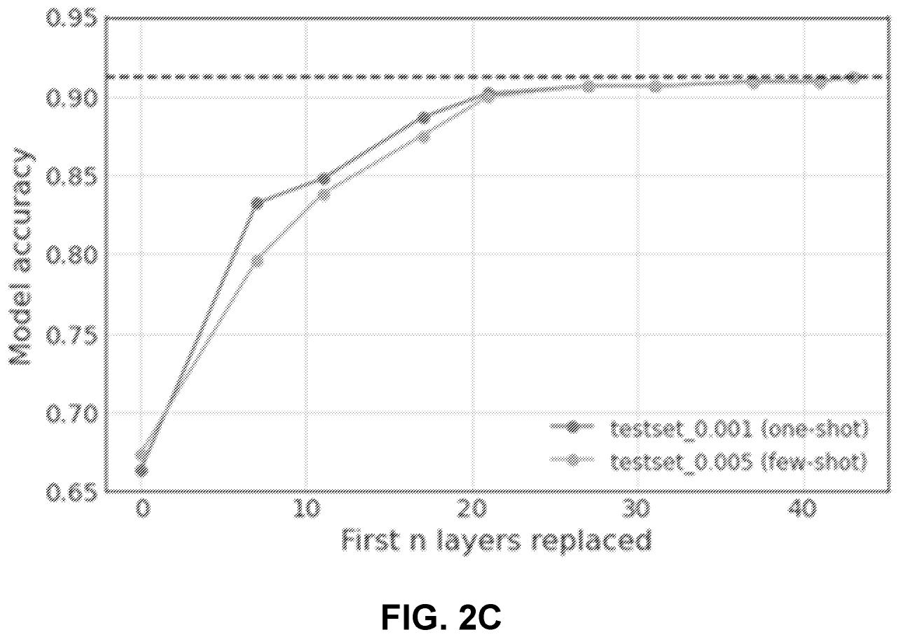

FIGS. 2A-2C illustrate synergies when quantizing a plurality of different metrics in an AI architecture, according to some embodiments. Previously, AI architectures only were known to quantize single metrics. For example, AI pipelines would only quantize the activation ranges individually. It was believed that quantizing additional metrics in the AI architecture would further degrade the accuracy of the model beyond acceptable limits. Furthermore, the bit representations of any field in the AI pipeline were not quantized to very low bit levels, such as 8 bits or fewer. However, it is been discovered that a plurality of metrics may be quantized together to perform synergistically and reduce the overall data representation size without degrading the accuracy of the model beyond an acceptable limit.

For example, FIG. 2A illustrates a table that shows the effect on the accuracy of the AI model when quantizing the activation bits and the weight bits together. Normally, when 32 bits are used for the activation bits and/or the weight bits, the accuracy is approximate 92%. As illustrated in this table, dynamically quantizing the activation bits to 8 or fewer bits and statically quantizing the weight bits to 8 or fewer bits has been shown to only minimally reduce the accuracy. Specifically, when a quantization range of 8 bits is used for both the activation and the weight, the accuracy is still almost 90%. Reducing both metrics to a quantization range of 6 bits still yields greater than 70% accuracy. Further reducing the quantization range below 6 bits plateaus the accuracy at a minimum of about 50%. Various optimization techniques may be used, such as knowledge distillation in machine learning.

FIG. 2B illustrates an example where the quantization range of the activation is reduced to 8 bits, and the quantization range of the weights are lowered to 8 bits and then fewer than 8 bits for another data set. In this example, the accuracy remains at about 90% when the weights are quantized to 8 bits or 7 bits. Further reducing the quantization range of the weights reduces the accuracy to about 50%.

FIG. 2C illustrates a graph of further optimizations in the neural network using mixed-precision quantization. As described in greater detail below, individual layers in the neural network may each be quantized to different bit-levels. This allows individual tile outputs from distributed operations to be optimized individually to reduce the bandwidth throughout the network. Specifically, the graph in FIG. 2C illustrates an example of a neural network where individual layers are quantized to either 8 bits or 4 bits, depending on the depth and the type of layer. The weights have been quantized dynamically and the activations have been quantized using a “few-shot” or “one-shot” calibration technique. As illustrated, the model accuracy can be largely maintained at greater than or about 90% accuracy with as much as 50% of the network layers being quantized to 4-bits, and the remaining network layers being quantized to 8-bits.

Although not illustrated explicitly in FIGS. 2A-2C, the weights and activations may also be quantized in coordination with the internal accumulator representations. For example, all three of these metrics may be reduced to approximately 8 bits or fewer. In order to synergistically optimize further reductions in the number of bits, static quantization may be used with test data or other representative data sets to test various combinations of quantization ranges between these three metrics. Simulated accuracy may then be used to identify optimal values for the quantization ranges for each metric. Alternatively, some embodiments may use dynamic quantization as described below.

The synergistic quantization of weights, activations, and accumulator bits may be linked together using various optimization techniques. For example, quantizing weights and activations to 8 or fewer bits may require the accumulator to be set to a higher precision (e.g., 32 bits), although the exact quantization for the accumulator may depend on the precision of model parameters. However, as described below, distributed workloads among a multi-chiplet architecture allows for the computation of partial sums for a single convolution operation, which can then be quantized to lower mixed-precision values.

Some embodiments of AI architectures may implement a method for quantizing a neural network. This method may include calculating a plurality of weights for the neural network during a training process for the neural network. These weights may then be quantized for the neural network. For example, the weights may be quantized to a range of about 8 bits or fewer. Similarly, the method may include quantizing outputs of various computational blocks in the neural network. This may include internal accumulator representations and/or output activations from computational blocks, such as portions of a MAC operation.

Various methods may be used for optimizing the quantization range and determining when this quantization should take place. For example, the weights may be quantized for the neural network prior to performing an inference operation to reduce the number of bits used to represent each of the weights. This may be referred to as static quantization. Alternatively, quantization may be performed during runtime when an inference operation is taking place. For example, the outputs of various computational blocks in the neural network may be quantized to dynamically quantize outputs during an inference operation. These different techniques are described in detail below.

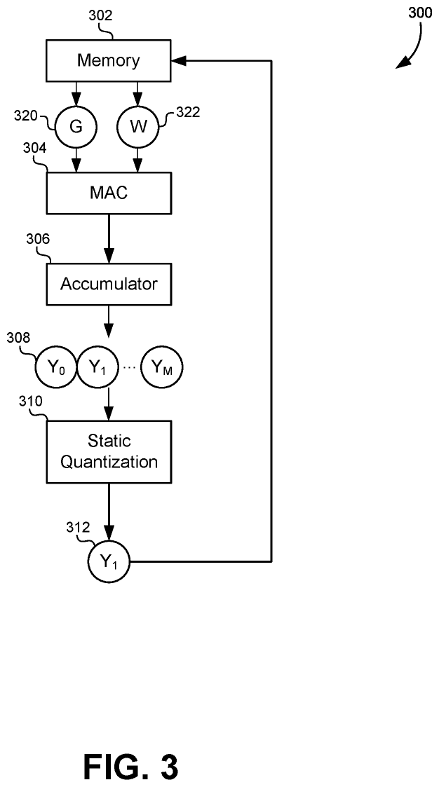

FIG. 3 illustrates an example of static quantization, according to some embodiments. FIG. 3 illustrates a portion of an AI pipeline 300 that includes a memory 302 that stores a plurality of weights 322 and a tensor or vector of data 320. The data 320 and the weights 322 may be retrieved from the memory 302 and provided to a multiply-accumulate (MAC) 304. The MAC 304 may perform the multiplication operations and provide the output to an accumulator 306. During static activation, the weights and activations of the model may be quantized after training and before inference. In this example, the outputs 308 of the accumulator 306 may be quantized by a static quantization function 310 (e.g., to 8 bits or fewer). The quantized output 312 of the accumulator 306 may then be loaded back into the memory 302 for use by a subsequent operation.

This type of static quantization may reduce the complexity of runtime procedures, but may not be ideal for inference workloads since the quantization is not typically customized for an individual workload when quantized statically. For example, no additional computational overhead needs to be performed during inference since the quantization will take place prior to performing the inference operation with the neural network. Since the quantization ranges (e.g., a minimum and maximum value for the data) may be set in advance. However, since the distribution of the data 320 may change with each workload, statically quantized accumulator outputs may perform very well for some workloads but not for others.

This type of static quantization may perform very well for quantizing the weights 322 used by the neural network. Since the weights typically only change during the training process, the weights may be statically quantized during or shortly after the training process and then used statically during inference. As described above, quantizing the weights may be combined with quantizing other metrics in the neural network. For example, statically quantized weights may be combined with quantizing outputs from any other computational block. For example, the MAC 304, the accumulator 306, and/or other functional blocks may be referred to generically as computational blocks. Thus, in addition to quantizing the weights, static or dynamic quantization may also be used to quantize outputs 308 of the accumulator 306 and any other data path in the AI pipeline 300.

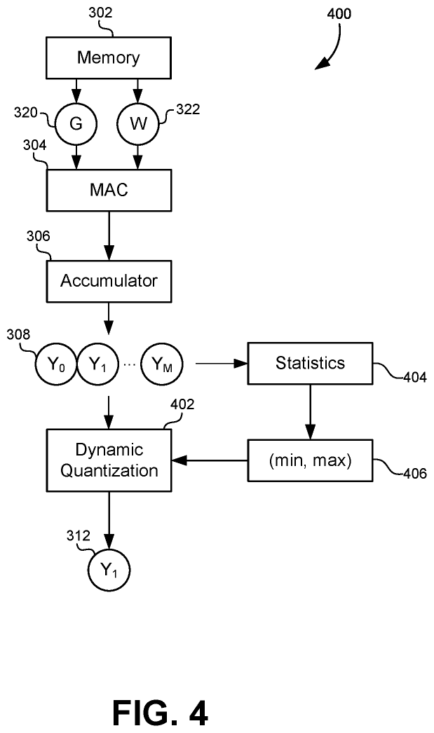

FIG. 4 illustrates an example of dynamic quantization, according to some embodiments. FIG. 4 illustrates the portion of the AI pipeline 400 as described above in FIG. 3, with certain modifications. In dynamic quantization, the weights may be still quantized ahead of time, while the activations may be quantized dynamically at runtime during inference. However, this type of dynamic quantization may introduce significant memory and compute overhead, especially when computing minimum and maximum values for quantization on the fly. For example, using dynamic quantization may result in an 8× increase in memory transfer and a 20% latency increase for inference. For example, as illustrated in FIG. 4, the accumulator outputs 308 and the statistics used in the dynamic quantization function 402 may need to be loaded to/from memory 404. The dynamic quantization function 402 may then compute the dynamic quantization parameters, which are then used to compute the quantized values for the quantization function 310.

For dynamic quantization, the quantization ranges may be determined based on the actual runtime data passing through the AI architecture. The operation may extract statistics 404 from the data distribution passing through the pipeline. In order to do so, the outputs 308 of the accumulator 306 may be written to memory and the statistics 404 may be calculated. The statistics may include characterizations of a distribution (e.g., a peak value, a value histogram, a standard deviation, a minimum value, a maximum value, and so forth). Calculating the statistics 404 at runtime may consume additional computational power and memory transfer.

After calculating the statistics 404, the operation may provide minimum/maximum values 406 for the quantization range to be applied by a dynamic quantization function 402. The dynamic quantization function 402 may apply the minimum/maximum values 406 to limit the range of the quantized output 312. While this basic dynamic quantization operation may work well with single layers, it is not well suited for distributed MAC operations since each dynamic quantization operation requires loading the tensor from memory, calculating statistics, and restoring the tensor. For example, dynamic quantization may require eight times the amount of memory transfer compared static quantization (e.g., for loading the accumulator output and statistics from memory, performing the quantization operation, and then saving the quantized output back to memory). Dynamic quantization may also add on average a 20% latency increase for inference operations. This overhead is not scalable when distributing the workloads across many chiplets.

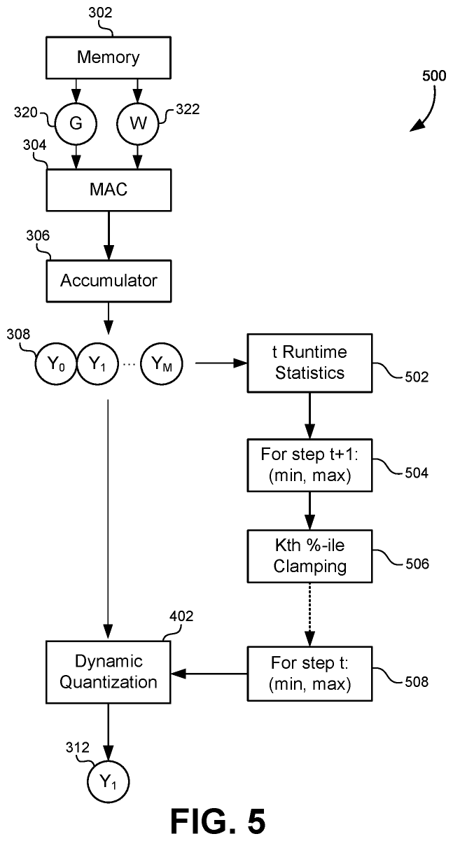

FIG. 5 illustrates an AI architecture 500 using a running statistical optimization for dynamic quantization, according to some embodiments. Specifically, this optimization may be implemented in hardware to reduce the compute overhead of dynamic quantization. Instead of calculating a quantization range for each individual iteration independently, a quantization range may be computed that is instead based on statistics from the partial activation distribution using minimum and maximum values as statistics. These values may be collected and determined from partial activation distributions by extracting them from the current tensor at runtime to update precomputed quantization parameters for the next iteration. These values can be calculated directly from the tensor values online in the network before they are stored to memory. This effectively eliminates the round-trip memory transfer previously required for dynamic quantization.

For example, to quantize the tensor at step t+1 (i.e., a subsequent step or iteration), the algorithm may use the set of quantization ranges from the current step t representing a current iteration. The statistics from the current iteration at step t may then be used to calculate the statistics for the next iteration at step t+1 in order to significantly reduce the memory overhead. For example, a hardware optimization may introduce a quantization module that calculates statistics (e.g., min and max values) for the current tensor to be used as an estimate for the next tensor. At the same time, the statistics from the previous tensor may be used to quantize the tensor in the online data path during the current step. The quantization module may track and calculate statistics from the accumulator output. The statistics may be initialized during the first batch using the min-max statistics from the first batch, and/or from a brief post-training, fine-tuning session to set the initial values.

For example, the quantization range may be defined as an exponential moving average of the minimum and maximum statistics of the output 308 of the accumulator 306. At each iteration, the runtime statistics 502 calculated from a previous iteration may be updated with data from the output 308 of the accumulator 306 in the current iteration. The updated statistics 502 may then be used to calculate a minimum and maximum value 504 to be used in a subsequent step. This minimum and maximum value 504 may be stored and used during the subsequent iteration. This process may be repeated for each tensor that passes through the pipeline of the AI architecture 500.

For the current iteration, the minimum and maximum value 508 calculated during the previous iteration may be used. For example, the minimum and maximum value 508 may be provided to the dynamic quantization function 402 to limit the range of the quantized output 312. The minimum and maximum value 504 may then be stored to be used as the minimum and maximum value 508 during the next iteration. The existing AI pipeline may be altered to add logic and hardware that calculates and stores the statistics from the accumulator between iterations. The estimate from these ranges may then be used to dynamically update the quantization range for the next iteration without the memory transfer and compute overhead described above in FIG. 4. The statistics may be initialized at the first time step t=0 with minimum/maximum values in the data set. Note that any statistics from the accumulator or tensor may be used. For example, minimum and maximum clamping values may be calculated using the following equations.

$$\begin{matrix}{q}_{min}^{t} = ( 1 - η ) min {G}^{t - 1} + η {q}_{min}^{t - 1} \\ {q}_{max}^{t} = ( 1 - η ) min {G}^{t - 1} + η {q}_{max}^{t - 1}\end{matrix}$$

This overhead may be further mitigated by when using dynamic quantization by using another optimization that may be implemented in hardware. By clamping the activation distribution with the minimum and maximum values, which may be updated continuously with an exponential moving average, some embodiments may further clamp the activation distribution to exclude the activation “tail ends” and thereby drop the least significant bits to effectively reduce the distribution spread. For example, the activation distribution may be clamped by taking the Kth percentile to exclude the distribution tail. Experimental results have shown that K may be determined such that the precision is dropped to 6-8 bits before seeing a drop in the accuracy of the overall output of the AI architecture. This same clamping procedure may also be used to eliminate the Kth percentile for weights that are statically quantized, as well as for the dynamically quantized activations and other computational outputs. When compared to previous dynamic quantization methods, this clamping procedure allows the quantization reduction to drop an additional 2-3 bits without losing accuracy. FIG. 5 illustrates how the tensors representing the output of the accumulator need not be written to memory, but instead may be analyzed online at runtime to update the statistics. Therefore, the time and memory required to write the statistics to memory will generally be orders of magnitude less than the time and memory required to store the output tensors from the accumulator.

By way of example, at step t (i.e., a current step or iteration), the current tensor may be used to compute statistics for the subsequent or next iteration at step t+1. Specifically, these statistics may be used to compute the parameters for the next time interval, which are then used to quantize the tensor at step t+1. This may be contrasted with previous solutions that performed all of these computations online during step t. This required the architecture to write the output of the accumulator to memory. Then the output of the accumulator would be loaded from memory to analyze the statistics for the current iteration, thereby incurring a significant increase in the memory overhead and compute latency. The statistics that are computed may characterize the distribution of a specific metric, such as the weights, the activations, internal accumulator representations, etc. The parameters that describe this distribution may then be used to quantize that distribution. Since the distribution is being reduced from a larger range to a smaller range, this reduces the precision representation of that metric or value. These parameters may include a minimum or maximum value.

Some embodiments may further reduce the quantization range by clamping the distribution at the Kth percentile. The statistics, such as the minimum and maximum values, which may be clamped according to the Kth percentile as described above, are generally much smaller than the data tensors output from the accumulator.

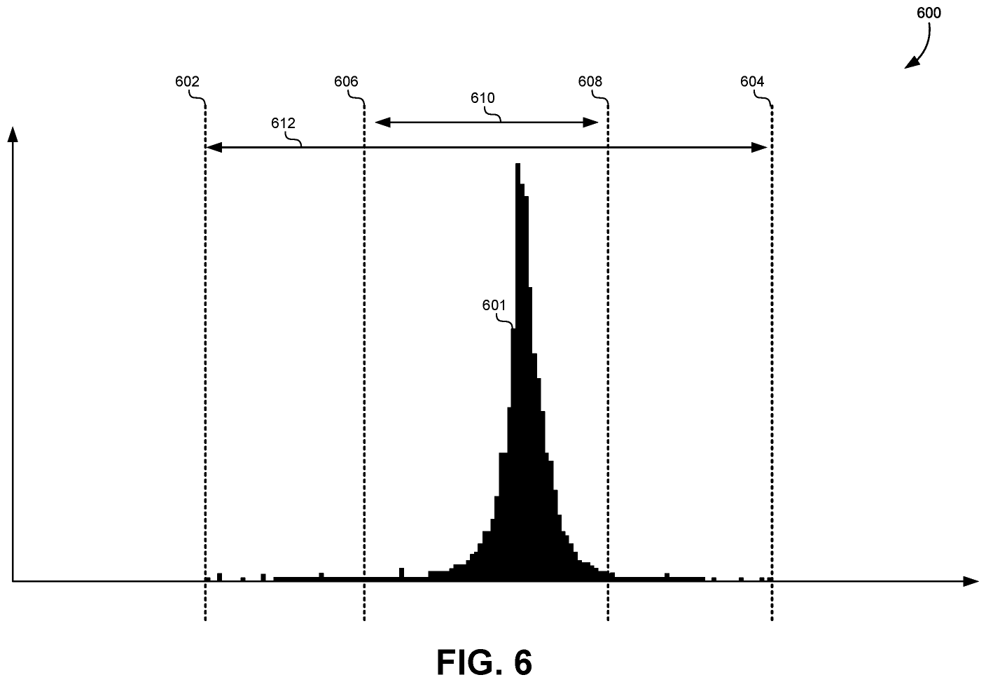

FIG. 6 illustrates a distribution of a metric, such as a set of weights or activations, according to some embodiments. The minimum statistic may be represented by line 602. The maximum statistic may be represented by line 604. The quantization range for the metric may include the range between line 602 and line 604. A value for K may be selected to be any value that excludes a desired least-significant portion of the distribution 601. By “clamping” the tail end of the distribution 601, the quantization range for the metric may be further reduced between line 606 and line 608. The value of K may be determined in order to correspond to a specific number of quantization bits, such as 8 bits, 7 bits, 6 bits, 5 bits, and so forth. The proper value for K may be determined experimentally easing simulation data or training data. The value of K may be adjusted until a specified accuracy threshold is reached or surpassed. In some embodiments, the value of K may be adjusted dynamically based on the statistics of the data set.

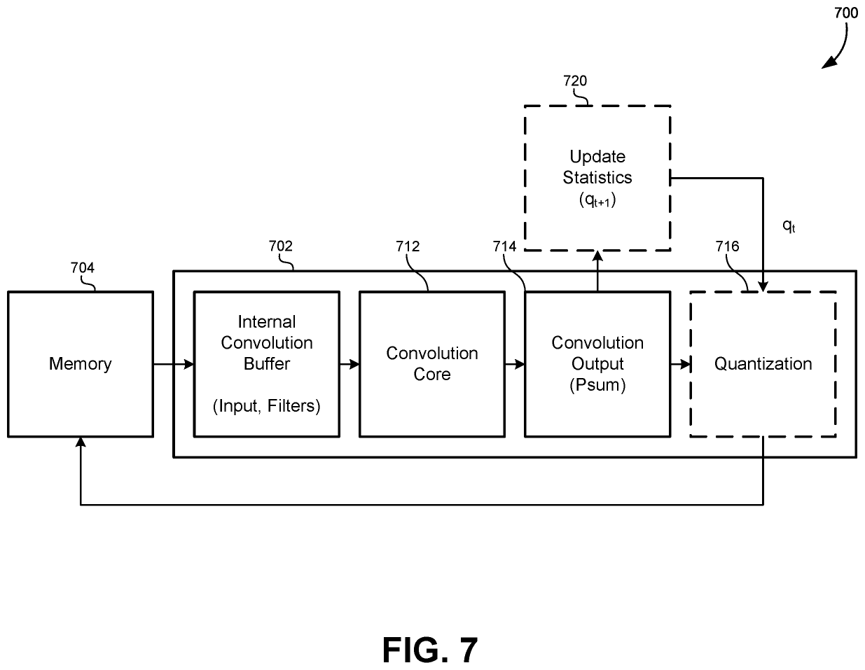

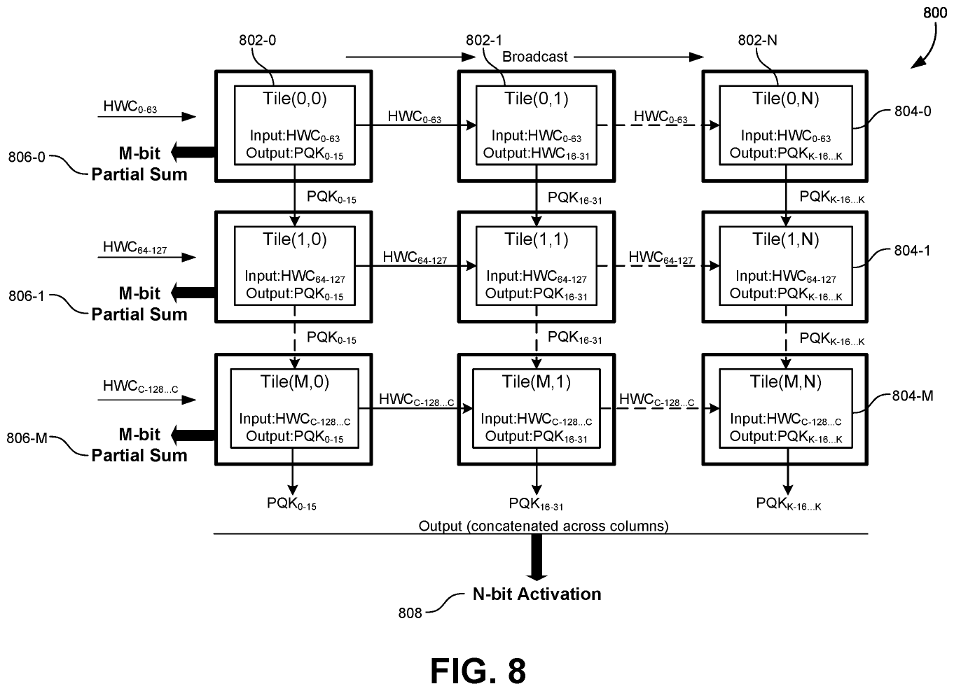

FIG. 7 illustrates a pipeline that may be used in an AI accelerator architecture, according to some embodiments. Specifically, an AI accelerator pipeline may include a memory 704, a core 712, such as a convolution core or other mathematical operation, and an output 714, such as a convolution output. The output 714 may represent a complete result in a stand-alone chiplet, or may represent a partial result (e.g., a partial sum) in a distributed chiplet architecture as described below in FIG. 8. The AI accelerator pipeline may also include an update statistic block 720 and a quantization block 716 configured to perform dynamic quantization operations.

As described above, this dynamic quantization optimization may be implemented in hardware. For example, the dynamic quantization optimization may be implemented in hardware by introducing a quantization block 716 to an accelerator architecture 700. In previous versions of a generic AI accelerator architecture, each of the outputs was written to memory before they were quantized dynamically, which affected off-chip and on-chip memories, internal buffers, math engines, and output accumulators. This optimized architecture 700 adds the quantization block 716 that quantizes the tensor based on earlier-calculated statistics directly to the pipeline. In order to prevent additional and unnecessary overhead to the compute and memory operations, the pre-computed quantization ranges may be used to enable efficient static quantization of the outputs directly without first storing the tensors in memory 704. Then, estimates of the quantization parameters for the next step for the dynamic quantization may be obtained by extracting new statistics from the output tensor during runtime. These runtime statistics may be extracted from the accumulator before the quantization step using added hardware logic.

The quantization block 716 may optionally use the Kth percentile as one of the statistics for clamping the activation distribution. As described above, this may allow the precision to be reduced to fewer than 8 bits before seeing a drop in accuracy. The quantization block 716 may use the previous estimations of the quantization parameters extracted from the output tensor. The quantization block 716 may then perform the clamping operation using the previous min-max values, and optionally further to the Kth percentile in order to reduce the quantization range to about 8 bits or fewer (e.g., about 6-8 bits) in a 32-bit system.

The update statistics block 720 in the accelerator architecture 700 may also include additional hardware that optimizes the accelerator architecture 700. For example, the update statistics block 720 may include logic that receives data or statistics from the convolution output 714 of the accelerator architecture 700. The update statistics block 720 may calculate new statistics that are used in a subsequent step by the quantization block 716. The update statistics block 720 may also include memory elements that provide the statistics from the previous step for the current step being clamped by the quantization block 716. However, the update statistics block 720 may directly extract values from the convolution output 714 tensor from the convolution core 712 instead of reading these values from the memory 704. While the output is computed, the internal logic may keep track of the min-max statistics from the accumulator. These statistics from the estimate from the current iteration may then be used to update the quantization ranges for the next iteration without the extra memory and compute overhead normally introduced by dynamic quantization. This method enables fast and efficient static quantization, which uses pre-computed quantization parameters.

In some embodiments, the update statistics block 720 and the quantization block 716 may include new hardware logic that are added to the traditional AI accelerator pipeline 702. This new hardware logic enables the outputs to be used directly from the convolution or accumulator output tensor rather than going to memory 704. This additional logic also allows the quantization to be performed dynamically to use the statistic approach (e.g., min/max), as well as the K^{th} percentile clamping described above.

This quantization block 716 may be implemented for each partial sum output in a distributed chiplet system described below. As described above, this enables a scalable chiplet architecture using multiple AI chiplets to compute partial sums. The data from these partial sums may then be combined by the convolution core 712 to generate a convolution output 714. Note that the update statistics block 720 and quantization block 716 may operate on the data live in the accumulator or convolution pipeline 702. Specifically, neither the quantization block 716 nor the update statistics block 720 need to retrieve data from the memory 704 in order to calculate statistics or perform the quantization operation. This may be contrasted with previous attempts to perform dynamic quantization that required the significant overhead of memory transfers.

As described above, for a multi-chiplet architecture, the workload may be distributed between a plurality of individual chiplets. The partial sums may be quantized to mixed-precision values using a dynamic quantization function 402. FIG. 8 illustrates a scalable chiplet architecture where partial sums are quantized, according to some embodiments. In a general sense, the multi-chiplet artificial intelligence processor may be arranged into a plurality of chiplets that are each configured to perform a portion of an inference operation by calculating partial sums are combined to generate an activation output.

Functionally, the chiplet architecture may be arranged in an array of individual tiles or chiplets. Each of the chiplets may calculate a partial sum in the inference operation. Each of the chiplet columns may introduce a K-split, where each of the chiplets calculate a partial sum across the K^{th} dimension. For example, the first column may calculate a partial sum for the first 16 output channels, the second column may calculate a partial sum for the second 16 output channels, and so forth. In many cases, the input tensor may include at least 32 bits, but may also include 64-bit, 128 bits, 256 bits, and so forth. Consequently, each row of chiplets may calculate a specific partial sum, taking the previous partial sum to combine with the next partial sum. This results in a two-dimensional mesh topology that splits across the K dimension and produces partial sums with K-splits. Each row may reduce the partial sum by combining a previous partial sum with the current partial sum being calculated.

In a generic AI accelerator, a partial sum may be computed using approximately two times the activation precision. For example, if the activation precision is approximate least 16 bits, the partial sum may be computed by setting the precision of the accumulator to approximately 32 bits. In contrast, the architecture illustrated above in FIG. 7 may set the precision of the accumulator to a fixed precision value of about 18 bits to about 20 bits. The partial sums may then be quantized dynamically using the clamping operation described above. The M-bit partial sums by then be combined across the K-split columns to produce a N-bit activation value 808. This N-bit activation may then further be downscaled to a lower quantization range (P bits) to achieve a final layer output. To summarize the example of FIG. 8, each clamped partial sum may be clamped to M bits to generate the N-bit activation 808 or activation output, which is then further quantized to a P-bit final layer output. This P-bit value represents the 6-8 bit value described above for the layer output.

Using mixed-precision quantization in the scalable chiplet architecture for the M×N chiplet array of FIG. 8 allows each tile to be quantized to a different precision. From the example of FIG. 7, the plurality of chiplets may include a plurality of quantization blocks implemented on the chiplets that are configured to individually quantize outputs from the respective chiplet. For example, a column may include the first M tiles quantized to 2 bits, followed by 4 bits, and so forth, depending on statistics computed from partial activation distributions. Additionally, each layer in the neural network may be quantized to individual, possibly different values. It may be assumed that as the partial sum is reduced in one column of the K-split, subsequent operations may be quantized to higher bit widths as the operation moves down the column of tiles. For example, the first row in a column may quantized to about 2 bits. Subsequent rows in the column may gradually increase, quantizing to 4 bits, 6 bits, and so forth. Some embodiments may stop this increase at about 8 bits. More generally, the plurality of chiplets may include a first chiplet in the second chiplet, and the output of the first chiplet media quantized to a different number of bits than the output of the second chiplet. In some cases, the first chiplet may receive the partial sum output from the second chiplet as depicted in FIG. 8. As described above, the output of the first chiplet may be quantized to a fewer number of bits (e.g., 2 bits to 6 bits) than the output of the second chiplet (e.g., 4 bits to 8 bits). Some embodiments may further use precision control in the accelerator, using techniques such as a hardware converter, truncation, a lookup table, and so forth, to keep track of different precision values. By using a quantized precision of between 2 bits and 8 bits, the reduction in bandwidth has been shown to be between about 15 Gb/s and about 60 Gb/s.

When utilizing different quantization ranges for each of the tiles, some embodiments may also introduce precision control in the AI accelerator architecture. This precision control for the AI accelerator architecture may include various techniques. Some embodiments may use conversion using offset, scaling, and shift operations treated as programmable registers, where saturation may be dependent on the number of output bits. Some embodiments may use truncation/clipping of the most significant bit (MSB) calculated from the (LSB+output_bits) to the least significant bit (LSB), which may also be treated as a programmable register. Some embodiments may use shifting for bias additions or a Lookup Table (LUT) for non-linearity.

Note that the 2D mesh topology illustrated in FIG. 8 is provided only by way of example and is not meant to be limiting. Any other topology that includes a plurality of chiplets performing partial sum operations may utilize the quantization methods described above. For example, an AI accelerator may be distributed between a plurality of chiplets using this quantization technique and scaled accordingly. Each of the tiles or chiplets illustrated in FIG. 8 or in another topology may be implemented using the quantization architecture illustrated and described above in FIG. 7. Thus, each tile may quantize the internal weights, activations bits, and outputs individually using the static and dynamic schemes described above. For example, the quantization blocks may be configured to quantize outputs on each of the chiplets using a statistic calculated from a previous input tensor during a previous inference operation, while also being configured to calculate a new statistic during the current inference operation to be used on a subsequent operation and/or input tensor.

Each of the methods described herein may be implemented by a computer system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user, or may be done automatically by a computer system without human intervention where any determinations are made by a processor. Furthermore, some embodiments of each of the methods described herein may be implemented as a set of instructions stored on a tangible, non-transitory storage medium to form a tangible software product.

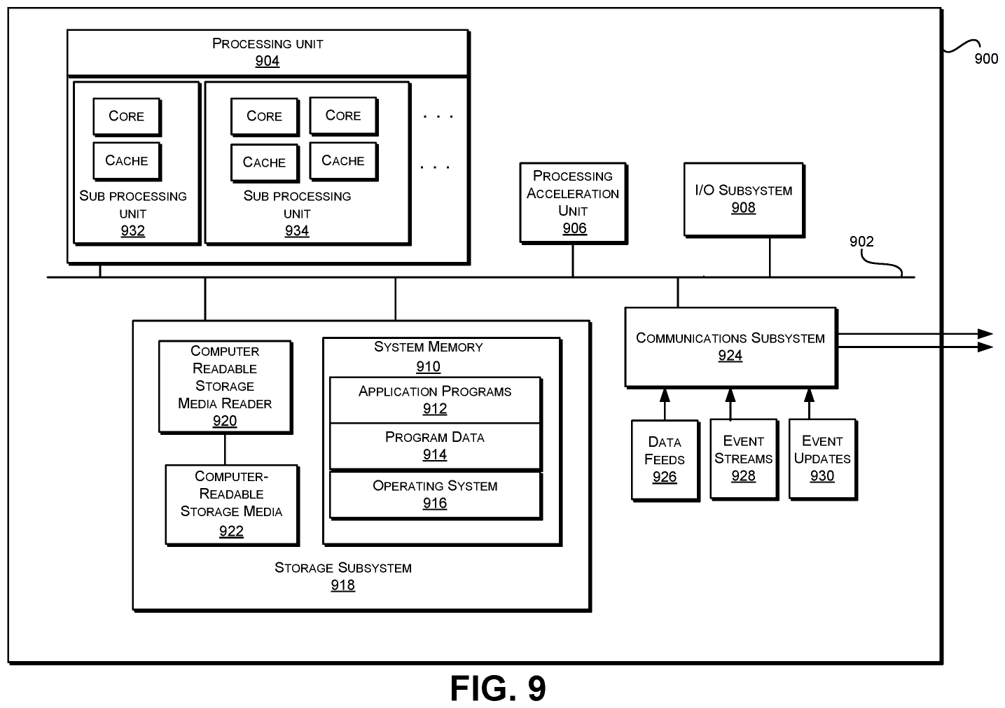

FIG. 9 illustrates an exemplary computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with some embodiments.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

As used herein, the terms “about” or “approximately” or “substantially” may be interpreted as being within a range that would be expected by one having ordinary skill in the art in light of the specification.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A multi-chiplet artificial intelligence processor comprising:
a plurality of chiplets each configured to perform a portion of an inference operation by calculating partial sums that are combined to generate an activation output; and
a plurality of quantization blocks that are implemented on the plurality of chiplets and configured to individually quantize outputs of each of the plurality of chiplets, wherein the plurality of chiplets comprises a first chiplet and a second chiplet, and an output of the first chiplet is quantized to a different number of bits than an output of the second chiplet.

2. The processor of claim 1, wherein:
the first chiplet receives a partial sum output from the second chiplet; and
the output of the first chiplet is quantized to a fewer number of bits than the output of the second chiplet.

3. The processor of claim 1, wherein:
the output of the first chiplet is quantized to between 2 bits and 6 bits; and
the output of the second chiplet is quantized to between 4 bits and 8 bits.

4. The processor of claim 1, wherein the plurality of chiplets are arranged in a two-dimensional (2D) grid, each column in the 2D grid processes a subset of bits from an input tensor comprising at least 32 bits, and each row in the 2D grid is quantized at greater than or equal to a number of bits in a previous row.

5. The processor of claim 1, wherein the activation output is further quantized to between 6 and 8 bits after combining the partial sums.

6. The processor of claim 5, wherein the quantization blocks are further configured to quantize the outputs of each of the plurality of chiplets using a K^{th} percentile after quantizing using a statistic from a previous input tensor.

7. The processor of claim 1, wherein the quantization blocks are further configured to quantize the outputs of each of the plurality of chiplets using a statistic from a previous input tensor.

8. The processor of claim 7, wherein the quantization blocks are further configured to calculate a statistic during the inference operation to be used on a subsequent inference operation with a subsequent input tensor.

9. An artificial intelligence (AI) accelerator pipeline comprising:
a core configured to perform an activation operation on an input tensor and generate an output tensor;
a memory that stores the input tensor and stores the output tensor after being generated by the core;
quantization logic configured to quantize the output tensor after being generated by the core and before being stored in the memory, wherein the quantization logic quantizes the output using a first statistic from a previous input tensor; and
update logic configured to calculate a second statistic that is stored and used by the quantization logic to quantize and output from a subsequent input tensor.

10. The AI accelerator pipeline of claim 9, wherein the quantization logic comprises hardware that quantizes the output tensor directly from the core such that the output tensor is not stored in the memory after being generated by the core and before being quantized using the first statistic by the quantization logic.

11. The AI accelerator pipeline of claim 9, wherein the update logic comprises hardware that calculates the second statistic directly from the core such that the output tensor is not stored in the memory after being generated by the core and before being used by the update logic to calculate the second statistic.

12. The AI accelerator pipeline of claim 9, wherein the quantization logic dynamically quantizes the output from the core during an inference operation.

13. The AI accelerator pipeline of claim 9, wherein the core comprises a plurality of internal weights that are statically quantized before performing an inference operation.

14. The AI accelerator pipeline of claim 13, wherein an internal accumulator is also quantized along with the plurality of internal weights and the output tensor, and the output tensor and the internal weights are quantized to 8 or fewer bits.

15. A method of performing an activation operation in an artificial intelligence (AI) accelerator pipeline, the method comprising:
performing the activation operation on an input tensor to generate an output tensor;
quantizing the output tensor before the output tensor is stored in a memory, wherein the output tensor is quantized using a first statistic calculated from a previous input tensor;
calculating a second statistic that is stored and used to quantize an output from a subsequent input tensor, wherein the second statistic is calculated from the output tensor before the output tensor is stored in the memory; and
storing the output tensor in the memory.

16. The method of claim 15, wherein the output tensor is quantized directly from the activation operation such that the output tensor is not stored in the memory after being generated and before being quantized using the first statistic.

17. The method of claim 15, wherein the second statistic is calculated directly from the output tensor after being generated and before being stored in the memory.

18. The method of claim 15, wherein the output tensor is dynamically quantized during an inference operation.

19. The method of claim 15, wherein a plurality of internal weights are statically quantized before performing an inference operation.

20. The method of claim 19, wherein an internal accumulator is also quantized along with the plurality of internal weights and the output tensor.
